(19) United States
(12) Patent Application Publication
(10) Pub. No.: US 2014/0278635 A1
(43) Pub. Date: Sep. 18, 2014

(54) DELIVERY METHODS AND SYSTEMS UTILIZING A STAND-BY DELIVERY DRIVER

(71) Applicant: Bringaroo, LLC, Phoenix, AZ (US)

(72) Inventors: Samuel T. Fulton, Chandler, AZ (US); Thomas G. Pittman, Gilbert, AZ (US); Matthew Scot Brown, Gilbert, AZ (US)

(73) Assignee: Bringaroo, LLC, Phoenix, AZ (US)

(21) Appl. No.: 14/157,312

(22) Filed: Jan. 16, 2014

Related U.S. Application Data
(60) Provisional application No. 61/792,205, filed on Mar. 15, 2013.

(51) Int. Cl. G06Q 10/06; G06Q 30/06; G06Q 10/08

(52) U.S. Cl. CPC G06Q 10/063112; G06Q 10/083; G06Q 30/0635
USPC 705/7.14; 705/7.13

(57) ABSTRACT

A system and related methods of a stand-by delivery driver is disclosed. The system may include a computer configured to prepare a stand-by driver pool of available stand-by drivers. The system further includes receiving a delivery request for a customer order and determining a ranked list of potential drivers to deliver the customer order. The system also includes selecting a potential driver from the ranked list of potential drivers and determining whether the potential driver accepts the delivery request. If the potential driver accepts the delivery request, the system includes transmitting an order authentication and receiving delivery notification from the delivery driver when the customer order is delivered to the customer. The system may also include transmitting driver-in-route notifications, providing real-time global positioning of the delivery driver. The system may be adapted for use in business delivery such as restaurant, local retail, legal, medical, pharmacy, online retail, and grocery delivery.

### CROSS REFERENCE TO RELATED APPLICATIONS

This document claims the benefit of the filing date of U.S. Provisional Patent Application 61/792,205, entitled “DELIVERY METHODS AND SYSTEMS UTILIZING A STAND-BY DELIVERY DRIVER” to Fulton which was filed on Mar. 15, 2013, the contents of which are hereby incorporated by reference.

### BACKGROUND

1. Technical Field

Aspects of this document relate generally to methods and systems of delivery.

2. Background Art

Offering local delivery from a business is cost prohibitive for many business owners. Generally, very few businesses offer local delivery services outside of the typical pizza chains, Chinese food, etc. The operating expenses of wages, benefits, insurance, vehicles expenses, and down time between deliveries is typically too cost prohibitive for most businesses to bear, particularly those working on traditionally tight profit margins.

### SUMMARY

According to one aspect, a computer-implemented method of delivery comprises receiving a delivery request for a customer order, the customer order associated with a business; selecting, by a computer, a first potential stand-by driver to deliver the customer order, the first potential driver selected from a pool of a plurality of potential stand-by delivery drivers, each of the plurality of potential stand-by drivers being independent of the business and permitted to accept or decline a delivery request; transmitting, by the computer, the delivery request to the first potential stand-by driver; receiving, by the computer, a first delivery response from the first potential stand-by driver, the delivery response accepting or declining the delivery request; assigning, by the computer, the first potential stand-by driver as a delivery driver if the first potential driver accepts a delivery request of the customer order; transmitting, by the computer, an order authentication to the delivery driver; receiving, by the computer, a pick-up notification when the delivery driver picks up the customer order from the business; and receiving, by the computer, a delivery notification when the delivery driver delivers the customer order to the customer.

Various embodiments of the method may comprise one or more of the following. Receiving, by the computer, a logon request from each of the plurality of potential stand-by drivers in the pool, each of the plurality of potential stand-by drivers. Selecting, by the computer, a second potential stand-by driver to deliver the customer order when the first potential stand-by driver declines the delivery request in the first delivery response, the second potential stand-by driver selected from the pool of potential stand-by delivery drivers; transmitting, by the computer, the delivery request to the second potential driver; receiving, by the computer, a second delivery response from the second potential stand-by driver, the second delivery response accepting or declining the delivery request; and assigning, by the computer, the second potential stand-by driver as a delivery driver if the second potential stand-by driver accepts a delivery request of the customer order. Receiving the delivery request for the customer order may comprise receiving, by the computer, the delivery request for the customer order from the customer. Receiving the delivery request for the customer order may comprise receiving, by the computer, the delivery request for the customer order from the business. Determining, by the computer, a ranked list of potential stand-by drivers from the pool of drivers, the ranked list based one or more driver criteria, wherein the first potential stand-by driver is ranked first on the ranked list and the second potential stand-by driver is ranked second on the ranked list. Transmitting the delivery request to the first potential stand-by driver may comprise transmitting the delivery request to a mobile device of the first potential stand-by driver with at least one of a text message, an email, or a push notification associated with an application on the mobile device. Receiving the first delivery response from the first potential stand-by driver may comprise receiving the first delivery response sent from the mobile device of the first potential stand-by driver, the first delivery response comprising at least one of a text message, an email, or a push notification that accepts or declines the delivery request. Transmitting the delivery request to the second potential stand-by driver may comprise transmitting the delivery request to a mobile device of the second potential stand-by driver with at least one of a text message, an email, or a push notification associated with the application on the mobile device of the second potential stand-by driver. Receiving the second delivery response from the second potential stand-by driver may comprise receiving the second delivery response sent from the mobile device of the second potential stand-by driver, the second delivery response comprising at least one of a text message, an email, or a push notification associated that accepts or declines the delivery request. Transmitting the order authentication to the delivery driver may comprise transmitting the order authentication to the mobile device of the delivery driver with at least one of a text message, email, or a push notification associated with the application on the mobile device of the delivery driver, the order authentication comprising at least one of a receipt, a code, a bar code configured to display on a mobile device of the delivery driver. Transmitting, by the computer, an estimated arrival time notification to at least one of the customer and the business. Transmitting, by the computer, an driver-in-route notification to at least one of the customer and the business. Providing, by the computer, real-time global positioning of the delivery driver. Receiving, by the computer, a business account charge request from the mobile device of the delivery driver. Charging, by the computer, a business account associated with the business a charge associated with delivery of the customer order. Storing, on an administrator database in communication with the computer, customer order information.

According to another aspect, a method of participating in a pool of stand-by delivery drivers comprises qualifying as a stand-by delivery driver; receiving, on a mobile device associated with the stand-by delivery driver, a delivery request from an administrator computer, the stand-by delivery driver selected by the administrator computer based on one or more driver criteria and the delivery request requesting delivery of a customer order associated with a business; transmitting, by the mobile device, a delivery response to the administrator computer, the delivery response accepting or declining the delivery request; receiving, on the mobile device, an order authentication when the delivery response is accepted; transmitting, by the mobile device, a pick-up notification to the administrator computer when the customer order has been picked up from the business; and transmitting, by the mobile device, a delivery notification to the administrator computer when the customer order is delivered to a customer.

Various embodiments may further comprise one or more of the following. Installing application software on the mobile device. Logging on, with the mobile device, as available to deliver on the administrator computer. Cancelling, with the mobile device, delivery request. Transmitting, by the mobile device, an estimated time of arrival to at least one of the business, the customer, and the administrator computer. Transmitting, by the mobile device, a photograph of the delivery driver to at least one of the business and the customer. Transmitting, by the mobile device, a signature of the customer to the administrator computer. Charging, on the mobile device, the customer for the customer order. Capturing, with the mobile device, a photograph of the customer order when the customer order is delivered. Contacting, with the mobile device, the customer to receive one or more additional delivery instructions. Receiving on the mobile device may comprise receiving at least one of a text message, an email, or a push notification associated with an application on the mobile device, and transmitting by the mobile device may comprise transmitting at least one of a text message, an email, or a push notification associated with the application from the mobile device. Qualifying as a stand-by delivery driver may comprise entering, on a computer, application information, the application information comprising at least one of personal information of the stand-by delivery driver, education, work experience, references, certification, vehicle information, and availability. Transmitting at least one of an executed contract, tax information, driver's license information, and insurance information to the administrator computer when the application information is approved.

According to another aspect, a computer-implemented delivery system comprises one or more computers associated with a central processor. The one or more computers are typically configured to do the following. Receive, from either a restaurant or a customer, a delivery request for a customer order. Determine a ranked list of potential drivers from a pool of a plurality of stand-by drivers, the ranked list based one or more driver criteria and each of the plurality of stand-by drivers being independent of the business and permitted to accept or decline a delivery request. Transmit to a first potential driver the delivery request to deliver the customer order, the first potential driver ranked first on the ranked list of potential drivers. Receive a first delivery response from the first potential driver, the first delivery response accepting or declining the delivery request. Assign the first potential driver as a delivery driver if the first potential driver accepts the delivery request. Transmit to a second potential driver the delivery request to deliver the customer order when the first potential driver declines the delivery request, the second potential driver ranked below the first potential driver on the ranked list of potential drivers. Receive a second delivery response from the second potential driver, the second delivery response accepting or declining the delivery request. Assign the first potential driver as a delivery driver when the first potential driver accepts the delivery request. Assign the second potential driver as the delivery driver when the second potential driver accepts the delivery request. Transmit an order authentication to the delivery driver. Receive a pick-up notification when the delivery driver picks up the customer order from the restaurant. Receive a delivery notification when the delivery driver delivers the customer order to a customer.

Various embodiments may comprise one or more of the following. The computer is configured to transmit the delivery request and the order authentication to the first potential driver and the second potential driver as at least one of a text message, an email, or a push notification associated with an application on a mobile device of the first potential driver or the second potential driver. The computer is configured to receive the first delivery response from the first potential driver sent from the mobile device of the first potential driver, the second deliver response sent from the mobile device of the second potential driver, and the pick-up notification and the delivery notification sent from the mobile device of the delivery driver as a text message, an email, or information entered into the API on the mobile device. The computer is further configured to transmit an estimated arrival time notification to at least one of the customer and the restaurant, transmit a driver-in-route notification to at least one of the customer and the restaurant, and transmit real-time global positioning of the delivery driver. The computer is further configured to receive a restaurant account charge request from the mobile device of the delivery driver, and charge a restaurant account associated with the restaurant a charge associated with delivery of the customer order. A database in communication with the computer, the database configured to receive and store delivery information.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

The methods and systems will hereinafter be described in conjunction with the appended drawings, where like designations denote like elements, and:

FIG. 1 is a block diagram of a system of delivery utilizing stand-by delivery drivers;

FIG. 2 is a representation of a communication network that allows communication between a customer, a business, an administrator computer, and a stand-by delivery driver;

FIG. 3 is a schematic block diagram illustrating a suitable operating environment for aspects of the disclosure;

FIG. 4 is a schematic block diagram of a sample computing environment;

FIG. 5 is a flowchart of a delivery system utilizing a stand-by delivery driver;

FIG. 6 is a flowchart of a computer implemented system of managing a delivery system utilizing a stand-by delivery driver; and

FIG. 7 is a flowchart of a method of participating in a stand-by driver pool.

### DESCRIPTION

This disclosure, its aspects and implementations, are not limited to the specific components or assembly procedures disclosed herein. Many additional components and assembly procedures known in the art consistent with the intended delivery system and method and/or assembly procedures for a delivery system and method will become apparent for use with implementations of a delivery system from this disclosure. Accordingly, for example, although particular electronic devices are disclosed, such electronic devices and implementing components may comprise any shape, size, style, type, model, version, measurement, concentration, material, quantity, and/or the like as is known in the art for such electronic device and implementing components, consistent with the intended operation of the electronic device in a delivery system.

Because of the cost-prohibitive nature of local delivery, few businesses offer the option of delivery to local customers or patrons. Various embodiments of systems and methods disclosed herein provide solutions to the cost-prohibitive nature of local delivery, as well as problems related to the hiring, management, and dispatch of delivery drivers. In one or more embodiments, a software application enables a pool of stand-by delivery drivers to be individually dispatched to deliver any product from a business to a customer in a defined delivery area. Embodiments of the software allow the delivery driver to deliver the product to the customer within minutes of the customer placing the order. As shall be described in greater detail herein, in an exemplary embodiment of the software application, the delivery driver: makes himself/herself available for deliveries, is selected from a list of other available delivery drivers in a queue, accepts a delivery job, and is dispatched to pick up the product at the business for delivery to the customer.

Advantages of the disclosures presented herein are numerous in comparison to previous delivery systems. First, utilizing of stand-by drivers saves businesses time and money. Whether the delivery drivers are employees or independent contractors in previous delivery systems, every minute the delivery drivers are not making a delivery costs money and creates inefficiencies. In contrast, a pool of stand-by, proximate delivery drivers can be dispatched to arrive at a business within twenty minutes and have a delivery completed within another 10-20 minutes. Once the delivery is made, the delivery driver is “off the clock.”

Numerous advantages are gained in the utilization of the embodiments disclosed herein. For example, the business is given a delivery service that can respond to a customer's needs in a quicker time, without incurring the normal fixed and variable costs of doing it themselves. Customers will be more satisfied with convenience and savings on gas and time. Businesses are enabled to sell more goods and compete against online retailers. Online retailers, on the other hand, are enabled to deliver not only more goods by utilizing stand-by drivers, but also deliver some goods faster. Online retailers may charge a premium for delivery within an hour (or other time frames) by utilizing stand-by driver pools described herein.

Any data which may be transmitted electronically over a cellular phone or cellular data or other communication network may be transmitted and this disclosure is not intended to limit the type or quantity of data transmitted through this description and certainly any data mentioned herein and more is contemplated for transmission using this method. Processors associated with any cellular device may, in some implementations, use the cellular data access service to access a network or Internet web site and upload data directly to that web site through an Internet connection accessed through the cellular device rather than transmitting the data to a processor directly associated with the user control account. Once the cellular device is contacted, the data requested and data is delivered to its intended destination, a processor associated with the user control account may automatically, as discussed elsewhere herein, or manually by direct user action, transmit information to the cellular service provider or cellular data access registration number registry.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary,” “example” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated that a myriad of additional or alternate examples of varying scope could have been presented, but have been omitted for purposes of brevity.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

In order to provide a context for the various aspects of the disclosed subject matter, FIGS. 2-4 and the related discussion are intended to provide a brief, general description of a suitable environment in which the various aspects of the disclosed subject matter may be implemented. While the subject matter is described throughout this document in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Thus, while reference may be made to a mobile device throughout this document, the mobile device may refer to any hand-held computing device. It is also contemplated that the mobile device may, in some instances, include any other computer system described herein. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 2, various embodiments of the methods and systems disclosed herein comprise one or more administrator computers 12 associated with a stand-by driver delivery system administrator, one or more delivery drivers 8, one or more customers 4, and one or more business 5. Each of these is able to communicate with the others through communication network 7. For example, the business 5 typically comprises one or more of the following that is configured to communicate with the administrator computer 12, the delivery driver 8, and/or the customer 4: a telephone, a computer, a smartphone or mobile device, a tablet computer, and the like. Similarly, the delivery driver 8 and the customer 4 typically also have access to one or more of the following communication devices: a telephone, a computer, a smartphone or mobile device, a tablet computer, and the like. The communication network 7 may comprise any communication network known in the art and suitable to carry out the communication described in this document. Moreover, the communication network 7 is configured to allow one party to communicate with another party, while preventing communication between other parties in certain circumstances. By way of example and not by limitation, communication between the administrator computer 12 and the delivery driver 8 is typically not accessible to the customer 4 or the business 5. Exceptions may be made, however, to increase efficiency of the delivery method.

With reference to FIG. 3, an exemplary environment 10 for implementing various aspects disclosed herein includes an administrator computer 12 (e.g., desktop, laptop, server, hand held processing device, cellular phone device, programmable consumer or industrial electronics, and the like). Computers or other electronic devices utilized by the customer 4, the business 5, and the delivery driver 8 may have features or components similar or equal to those described in relation to the administrator computer 12. Moreover, the administrator computer 12 or any computer or electronic device disclosed herein may comprise a series of multiple computers or electronic devices. The administrator computer 12 includes a processing unit 14, a system memory 16, and a system bus 18. The system bus 18 couples system components including, but not limited to, the system memory 16 to the processing unit 14. The processing unit 14 can be any of various available microprocessors. It is to be appreciated that dual microprocessors, multi-core and other multiprocessor architectures can be employed as the processing unit 14.

The system memory 16 includes volatile and nonvolatile memory. The basic input/output system (BIOS), containing the basic routines to transfer information between elements within the computer 12, such as during start-up, is stored in nonvolatile memory. By way of illustration, and not of limitation, nonvolatile memory can include read only memory (ROM) in some cases. Volatile memory includes random access memory (RAM), which can act as external cache memory to facilitate processing.

The administrator computer 12 may also include removable/non-removable, volatile/non-volatile computer storage media. FIG. 3 illustrates, for example, mass storage 24. Mass storage 24 includes, but is not limited to, devices like a magnetic or optical disk drive, floppy disk drive, flash memory, Internet cloud memory, or memory stick. In addition, mass storage 24 can include storage media separately or in combination with other storage media.

FIG. 3 provides software application(s) 28 that act as an intermediary between users and/or other computers and the basic computer resources described in suitable operating environment 10. Such software application(s) 28 include one or both of system and application software. System software can include an operating system, which can be stored on mass storage 24, that acts to control and allocate resources of the administrator computer system 12. Application software 28 takes advantage of the management of resources by system software through program modules and data stored on either or both of system memory 16 and mass storage 24. Database data may be stored in system memory 16, mass storage 24, or some other storage associated with the administrator computer 12. Software application(s) 28 may also be installed and utilized on any mobile device or computer, as shall be described in greater detail below.

The administrator computer 12 also includes one or more interface components 26 that are communicatively coupled to the bus 18 and facilitate interaction with the administrator computer 12. By way of example, the interface component 26 can be a port (e.g., serial, parallel, PCMCIA, USB, FireWire, and the like) or an interface card (e.g., sound, video, network, and the like) or the like. The interface component 26 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 12 to output device(s) via interface component 26. Output devices can include displays (e.g., CRT, LCD, plasma, projection, and the like), speakers, printers and other computers, among other things.

FIG. 4 is a schematic block diagram of a sample-computing environment 30 with which the subject innovation can interact. The system 30 includes one or more client(s) 32, for example, associated with a delivery driver, the customer, or the business. The client(s) 32 can be hardware and/or software (e.g., threads, processes, computing devices). The system 30 also includes one or more server(s) 34. Thus, system 30 can correspond to a two-tier client server model or a multi-tier model (e.g., client, middle tier server, data server), amongst other models. The server(s) 34 can also be hardware and/or software (e.g., threads, processes, computing devices). The servers 34 can house threads to perform transformations by employing the aspects of the subject innovation, for example. One possible communication between a client 32 and a server 34 may be in the form of a data packet transmitted between two or more computer processes while transmitting data from an account interface displaying on an account owner's computing device and an interface processor, or between an interface processor and an account owner's phone and/or data service carrier or a phone number and/or registration number registry, or between a phone and/or data service carrier and a phone number and/or registration number registry. A communication framework 38 exists between the one or more client(s) 32 and the one or more server(s) to facilitate meaningful data transfer and communication.

FIG. 1 is a schematic block diagram of a broad overview of one embodiment of a stand-by driver delivery system and related method. In one or more embodiments, a stand-by driver delivery system comprises three separate aspects, systems, or phases: a stand-by pool system 1, a selection dispatch system 2, and a hiring system 3. The hiring system 3 typically comprises an applicant pool 52 and an applicant tracking database server 52 associated with administrator computer 12.

From the applicant pool, a computer screening 56 and human screening may qualify the applicant to be a stand-by driver. Computer screening 56 may be completed by the applicant on any of the various electronic described herein or otherwise known in the art, including but not limited personal computers, tablet computers, mobile cellular devices, and the like. In some embodiments, computer screening is facilitated with one or more software applications 28. Particular embodiments of a software application utilized in the hiring system 3 comprise a questionnaire that includes one or more of the following applicant information requests: personal information, education, work experience, references, certifications, vehicle information, availability, and/or mobile device or smart phone accessibility. The questionnaire is typically transmitted through a communication network 7 to the administrator computer 12. In alternative embodiments, the questionnaire may be completed over the telephone, in person, or on paper.

Human screening 60 may be conducted in person, online, or by any other manner of human screening known in the art. Once human screening 60 takes place, the applicant is either approved or denied. If the applicant is approved, driver initialization 62 takes places. Driver initiation 62 comprises one or more of the following: contract execution, W-9 or other tax information, driver's license information, proof of insurance, and/or software application setup on the mobile device of the newly hired applicant. The software may comprise an embodiment of a software application 28 that communicates with the administrator computer 12 as described herein.

Once an applicant qualifies as stand-by driver, he/she enters the stand-by driver pool 70 of the stand-by pool system 1. In various embodiments, the stand-by driver is required to logon in order to be an active or available member of the stand-by driver pool 70. A driver tracker database server 58 associated with central computer stores and, in some embodiments, determines what stand-by drivers in the stand-by driver pool 70 are contacted and in what order.

When the administrator computer 12 receives a customer order for a business 5, a stand-by driver from the stand-by driver pool 70 is selected as part of the selection dispatch system 2. In one or more embodiments, the administrator computer 12 determines whether or not the delivery system accepts the customer order. For example, in particular embodiments, the administrator computer 12 and/or the software application 28 calculates the mileage between the business and the customer, and then determines whether the locations are within the prescribed parameters. If the locations of the business and/or the customer are beyond the parameters of the delivery system, delivery by a stand-by driver may occur at a loss—and thus the delivery request may be declined.

Selection of the stand-by driver from the stand-by driver pool 70 may be based upon a ranked list determined by the administrator computer 12. Ranking of stand-by drivers in the stand-by driver pool may be based upon an algorithm that considers one or more of the following factors: whether the stand-by driver is currently on a delivery; the percentage of the current delivery of the stand-by driver completed; the average number of delivery opportunities accepted by the stand-by driver compared to other available stand-by drivers; the average delivery availability of the stand-by driver (how often and how long does the stand-by driver make himself available for deliveries); what stand-by driver has denied more delivery opportunities; length of tenure of the stand-by drivers; the most accurate stand-by driver, i.e. the route driven by the stand-by driver and the least customer service issues); proximity of the stand-by driver to the business where items will be picked up; proximity of the stand-by driver to customer where items will be delivered; whether the stand-by driver has a vehicle sized compatibly with the customer order; approximate weight of the customer order; whether the customer order is frozen or refrigerated and whether the stand-by driver has a cooler accessible; duration since last delivery opportunity for each stand-by driver; customer satisfaction for each stand-by driver; training and/or certification of each stand-by driver for particular customer orders, such as but not limited to medication, volatile liquids, medical devices, bodily fluids, notary public needed at time of delivery, over twenty-one years of age for alcohol delivery; whether the stand-by driver is certified with management associated with the administrator computer 12; whether past deliveries of the stand-by driver have resulted in damaged customer orders that were refused or complained of by the customer; whether the stand-by driver can pay for customer orders or other items from his/her personal account prior to reimbursement by either the business or management associated with the administrator computer 12; whether multiple deliveries are available from one business and/or nearby business, thus improving stand-by driver efficiency; whether the stand-by driver is logged in and/or available to accept a delivery request for a customer order; manager input/rating of the stand-by driver; restaurant preference/rating of each stand-by driver; whether the stand-by driver has previously delivered custom orders from a particular business; average delivery time of each stand-by driver; and/or average tips received for each stand-by driver. Accordingly, the administrator computer 12 is configured to store all information relevant to the ranking of stand-by drivers.

One or more embodiments of a stand-by driver delivery system may be tailored for any of a variety of industries, services, and the like. Thus, the business 5 may comprise at least one of a restaurant, retailers, pharmacies, hospitals, legal firms, construction firms, grocery stores, a distribution center for a national or international organization, an online retailer, and the like. The customer 4 may comprise any type of customer involved in any of a variety of transactions. In particular embodiments, the customer 4 is a customer of an end product provided by the business 5. In other embodiments, the customer 4 is a business that uses the product provided the business 5 in the customer's 4 business. In still other embodiments, the delivery driver 8 may pick-up customer orders from a plurality of businesses 5 to deliver to a single customer 4.

FIG. 5 is a flowchart of an exemplary embodiment of a stand-by delivery driver system or method. As the flowchart shown in FIG. 5 is merely one of many embodiments, other embodiments may include additional aspects, exclude certain aspects, or reorder order certain aspects shown in FIG. 5. In one or more embodiments, a customer 4 places a customer order (step 102) for one or more products associated with one or more businesses 5. The customer 4 may place the order in a variety of ways, such as but not limited to: online with business 5; online with the administrator computer 12; over the phone with the business 5; over the phone with the administrator; in person with the business 5; or in person with the administrator. Customer orders, whether received directly from the business 5 or the customer 4, may be received via any electronic communication, such as but not limited SMS text message, email, facsimile, social media (Facebook, Twitter), application programming interfaces, or websites. In particular embodiments, the administrator promotes the business 5 with online, radio, flier, and/or newspaper advertisements. In such embodiments, a customer 4 contacts the administrator or the administrator computer 12, and the places the customer order. The administrator may then transmit an order notification to the business 5.

In embodiments wherein the customer 4 places the customer order with the business 5, the business 5 then sends to the customer order to the administrator (step 104). The business 5 may send the customer order to the administrator in a variety of ways, such as but not limited to sending the customer order electronically to the administrator computer 12 or over the phone with the administrator. Electronic transmission of the customer order from the business 5 to the administrator computer 12 may be with a software application 28 and/or over the Internet. The administrator may enter the customer order into the administrator computer 12 manually, or, alternatively, the customer order may be automatically entered into the administrator computer 12. In a particular embodiment, the business 5 places a call to a call-center associated with the administrator.

Once the delivery request for the customer order is received by the administrator computer 12, whether electronically or manually, the customer order enters a queue on the administrator computer 12. The order queue, in one or more embodiments, comprises a queue of active, past, and/or future delivery requests for customer order. The customer orders within the order queue may be released based on committed delivery timeframe to maximize batching of the customer orders.

After delivery request for the customer order is released (step 108), the delivery request for the customer order is dispatched (step 110). Dispatch of the delivery request for the customer order may be accomplished through a variety of mechanisms or actions. A first stand-by delivery driver 8 may be selected (step 112) through the ranked list previously described, or through other selection methods. The delivery request may be transmitted electronically to a stand-by delivery driver 8 in the stand-by delivery driver pool 70 through an SMS text message, push notification alert on the software application 28 on the mobile device of the stand-by delivery driver 8, or an email. Alternatively, the delivery request may be transmitted through a call-center that calls a phone number associated with the stand-by delivery driver 8, such as a cell phone number or home phone number.

Once received, the first stand-by delivery driver may either accept or decline the delivery request (step 114). If the stand-by delivery driver declines the delivery request, then a second stand-by delivery driver is selected from the stand-by delivery driver pool 70 and the second stand-by delivery driver receives the delivery request. Once a stand-by delivery driver 8 from the stand-by delivery driver pool 70 accepts the delivery request (step 116), the delivery driver 8 departs for the business 5 (step 118). In some embodiments, at least one of the business 5 and/or the customer 4 is notified (step 120) that the delivery driver 8 has accepted the delivery request. The notification to the business 5 and/or the customer 4 may include one or more of the delivery driver information, the estimated time of arrival at the business 5 or the customer 4, or an order authentication. The order authentication may comprise one or more of the following: an electronic receipt, a bar code, an alpha/numeric code, and the like.

Once the delivery driver 8 arrives at the business (step 122), the delivery driver 8 may be authorized (step 124) by presenting the order authentication to the business 5. The delivery driver 8 may then pick up the customer order and other order related information (step 126). The other order related information may comprise but is not limited to sales slips and customer information. When the delivery driver 8 has the necessary customer order and related information, the delivery driver 8 departs the business 5 (step 128). In one or more embodiments, the customer 4 is notified, via any of the communication methods previously described, that the delivery driver 8 has departed and is in route (step 130). In one or more embodiments, the administrator computer 12 is also notified when the delivery driver 8 departs the business 5 to deliver the customer order to the customer 4.

When the delivery driver 8 arrives at the customer's desired location (step 132) the delivery driver 8 takes payment from the customer (step 134) and delivers the customer order to the customer 4 (step 136). Payment for the customer order may comprise at least one of cash, credit/debit card, or a billing account. The delivery driver 8, in certain embodiments, also delivers documents to the customer (step 138). Documents may include receipts or other documents related to the purchase and/or delivery transaction. In one or more embodiments, the delivery driver 8 returns to the business 5 to delivery payment and/or tip-out. Other methods of payments are disclosed elsewhere in this document.

In circumstances wherein the driver does not deliver the customer order to the customer 4 within a specified time frame, an automated call, text message, push notification, or any other communication may be made to the delivery driver 8. If the delivery driver 8 does not respond, a notification may be sent to a supervisor of the delivery driver 8, and a new delivery driver selected from the stand-by driver pool 70. In one or more embodiments, the system is configured to allow the customer 4 to schedule a customer order in advance for future delivery times.

FIG. 6 illustrates an exemplary flow chart of a computer implemented system or method of delivery utilizing one or more stand-by delivery drivers. As the flowchart shown in FIG. 6 is merely one of many embodiments, other embodiments may include additional aspects, exclude certain aspects, or reorder order certain aspects shown in FIG. 6. In one or more embodiments, the administrator computer 12 receives a delivery request for a customer order (step 202). The delivery request for the customer may be received by the administrator computer in a variety of manners, such as but not limited to manual entry into the administrator computer 12 after receiving a telephone call at a call center from either a business 5 or a customer 4, or automatic entry into the administrator computer 12 after the administrator computer 12 receive electronic communication from at least one of a business 5 or a customer 4.

In one or more embodiments of a system or method of delivery utilizing one or more stand-by drivers, the administrator computer 12 prepares a stand-by driver pool 70 of stand-by delivery drivers. The stand-by driver pool 70 may be prepared in various manners. In some embodiments, the stand-by driver pool 70 is prepared or compiled as stand-by drivers logon to the system from a computer, mobile device, or other electronic device, and set their status as “available” on the administrator computer 12. In other embodiments, the stand-by driver pool 70 is prepared based upon a list of stand-by delivery drivers available at pre-determined or adjustable times of the day and/or certain days of the week. In still other embodiments, the stand-by driver pool 70 is prepared or compiled as stand-by drivers call into the administrator or otherwise notify the administrator of their availability.

In one or more embodiments of a system or method of delivery utilizing one or more stand-by drivers, the administrator computer 12 determines a ranked list of potential stand-by drivers (step 204). In some embodiments, the ranked list of potential stand-by drivers is compiled based on stand-by drivers in the stand-by driver pool 70. In other embodiments, the ranked list of potential stand-by drivers is compiled based on any drivers in the administrator database, whether or not the stand-by drivers are logged on and active in the stand-by driver pool 70. Ranking of the stand-by drivers on the ranked list may be based upon one or more of any of the factors previously described in this document.

In one or more embodiments of a system or method of delivery utilizing one or more stand-by drivers, the administrator computer 12 prepares or compiles a stand-by driver pool 70. The stand-by driver pool 70 is typically prepared or compiled by as potential stand-by drivers logon to the system. In some embodiments, potential stand-by drivers enter the stand-by driver pool 70 after logging into the system and then setting their status to “available.”

In one or more embodiments of a system or method of delivery utilizing one or more stand-by drivers, the administrator computer 12 selects a first potential stand-by driver to deliver the customer order to the customer (step 206). The first potential stand-by driver may be selected from the stand-by driver pool 70, or may, alternatively be a stand-by driver not in the stand-by driver pool 70 when selected. Moreover, whether in the stand-by driver pool 70 or not, the first potential stand-by driver may be selected from the ranked list of potential stand-by drivers in various embodiments. In a particular embodiment, the first potential stand-by driver is the top or highest ranked stand-by driver on the ranked list of potential stand-by drivers. In other embodiments, the first potential stand-by driver is not required to be the top ranked stand-by driver on the ranked list of potential stand-b driver, but may alternatively be selected based on additional criteria or an override by an administrator.

In one or more embodiments of a system or method of delivery utilizing one or more stand-by drivers, a delivery request is communicated to the first potential stand-by driver (step 206). The delivery request comprises, in some embodiments, information pertaining to the customer order, such as but not limited to the contents of the customer order, the business or business associated with the customer order, the location or locations of the business or businesses associated with the customer order, the location of the customer or customers, an approximate time of expected pick-up, an approximate time of expected delivery, any special handling instructions, any certifications required for delivery, and the like. The delivery request is, in various embodiments, communicated to the first potential stand-by driver by way of one or more of the following: a telephone call, a text message, an email, a push notification on the mobile device of the first potential driver, and the like. In some embodiments, the administrator computer transmits the delivery request to the first potential stand-by driver, while in other embodiments, an individual associated with the administrator contacts the first potential stand-by driver.

In one or more embodiments of a system or method of delivery utilizing one or more stand-by drivers, the administrator and/or the administrator computer 12 receives a first delivery response from the first potential stand-by driver (step 210). In some embodiments, the first potential stand-by driver calls the administrator to communicate the first delivery response, while in other embodiments, the first potential stand-by driver transmits the first delivery response to the administrator computer 12 via a computer, a mobile device or cell phone, or a telephone. In some embodiments, the first potential stand-by driver transmits the first delivery response with a text message, an email, a voice mail, verbal voice recognition, touch tone, and/or data entry on the software application 28 of a computer or mobile device that is transmitted to the administrator computer 12.

In one or more embodiments, the first delivery response comprises accepting the delivery request, declining the delivery request, or postponing the delivery request. If the first delivery response accepts the delivery request, the system or method continues to step 212. If the first delivery response declines the delivery request, the system or method continues to step 214. If the first delivery response postpones the delivery request, the system or method continues to step 214, with the potential that the system or method may return to step 208 at a later time. For example, if the first delivery response postpones the delivery request, other potential stand-by drivers in the stand-by driver pool may be contacted. If no stand-by delivery drivers are accepted or a preset time has passed since the delivery request was first communicated, the delivery request may be communicated to the first potential driver a second time.

In one or more embodiments of a system or method of delivery utilizing one or more stand-by drivers, if the delivery request is accepted by the first potential stand-by driver, the first potential stand-by driver is assigned as the delivery driver (step 212). Either the administrator or the administrator computer 12 may assign the first potential driver as the delivery driver.

In one or more embodiments of a system or method of delivery utilizing one or more stand-by drivers, if the delivery request is declined by the first potential stand-by driver, a second potential stand-by driver is selected by the administrator computer 12 (step 216) or an administrator. The second potential stand-by driver may be ranked second on the ranked list of stand-by drivers or lower than the first potential stand-by driver on the ranked list of stand-by drivers. In some embodiments, the ranked list is determined again after the first potential stand-by driver declines the delivery request. This allows for the potential of previously unavailable stand-by drivers to now be available. In determining the ranked list again, the first potential stand-by driver may be included or excluded. Thus, the second stand-by driver may be ranked higher than the first stand-by driver when the second stand-by driver is selected by the administrator computer.

In one or more embodiments of a system or method of delivery utilizing one or more stand-by drivers, the delivery request is transmitted to the second potential stand-by driver and a second delivery response is received from the second potential stand-by driver in a manner similar to that previously described with the respect to the first potential stand-by driver. If the second potential stand-by driver declines or postpones the delivery request in the second delivery response, the delivery request may be sent to a third potential stand-by driver, a fourth potential stand-by driver, a fifth potential stand-by driver, and so on as is necessary to find a stand-by driver who accepts the delivery request. After the delivery request is declined by a potential stand-by driver, the ranked list may be determined once again, or the initial ranked list may be utilized to determine the next available stand-by driver. If the delivery request is accepted by the second potential stand-by driver, the second potential stand-by driver is assigned as the delivery driver (step 220). Either the administrator or the administrator computer 12 may assign the second potential stand-by driver as the delivery driver.

In one or more embodiments of a system or method of delivery utilizing one or more stand-by drivers, an order authentication is transmitted from the administrator computer 12 to the delivery driver 8 (step 222). The order authentication may be transmitted in any manner previously described herein or otherwise known in the art, such as but not limited to a text message, an email, or a push notification on the mobile devices of the user. The order authentication may comprise any information previously described.

In one or more embodiments of a system or method of delivery utilizing one or more stand-by drivers, an estimated business arrival time notification is transmitted or otherwise communicated to at least one of the business 5 and the customer 4 (step 224). The estimated business arrival time notification may be communicated via the telephone, or alternatively through any suitable electronic communication from the administrator computer 12, such as but not limited to a text message, an email, a push notification, and the like. The estimate business arrival time notification typically comprises an estimated time the delivery driver will arrive at the business 5 to pick up the customer order.

In one or more embodiments of a system or method of delivery utilizing one or more stand-by drivers, the administrator computer 12 is configured to receive a pick-up notification from either or both the business 5 and/or the delivery driver 8 (step 226). The pick-up notification typically notifies the administrator the customer order has been picked up by the delivery driver 8. The pick-up notification may be communicated via the telephone, or alternatively through any suitable electronic communication from the business to the administrator computer 12, such as but not limited to a text message, an email, a push notification, and/or electronic correspondence between software applications 28.

In one or more embodiments of a system or method of delivery utilizing one or more stand-by drivers, the administrator communicates a driver-in-route notification to the customer 4 (step 228). The driver-in-route notification typically notes that the delivery driver 8 has picked-up the customer order from the business 5, and has departed from the business 5 to deliver the customer order to the customer 4. The driver-in-route notification may be communicated via the telephone, or alternatively through any suitable electronic communication from either or both the administrator or the administrator computer 12, such as but not limited to a text message, an email, and/or a push notification.

In one or more embodiments of a system or method of delivery utilizing one or more stand-by drivers, the administrator computer 12 is configured to communicate an estimated customer arrival time notification from to the customer 4 (step 230). The estimated customer arrival time notification typically notes at estimated or approximate time that the delivery driver should deliver the customer order to the customer 4. The estimated customer arrival time notification may be communicated via the telephone, or alternatively through any suitable electronic communication from either or both the administrator or the administrator computer 12, such as but not limited to a text message, an email, and/or a push notification.

In one or more embodiments of a system or method of delivery utilizing one or more stand-by drivers, the administrator computer 12 is configured to provide real-time global positioning of the delivery driver 8 (step 232). The real-time global positioning of the delivery driver may be provided to at least one of the customer 4 and/or the business 5, and may be accessed through software applications 28 on computers, mobile devices, or other electronic devices of the either the customer 4 or the business 5.

In one or more embodiments of a system or method of delivery utilizing one or more stand-by drivers, the administrator computer 12 is configured to receive a delivery notification from either or both of the customer 4 and/or the delivery driver 8 (step 234). The delivery notification typically notes that the customer order has been delivered, and may be communicated to the administrator computer 12 via the telephone, or alternatively through any suitable electronic communication, such as but not limited to a text message, an email, and/or communication between software applications 28.

In one or more embodiments of a system or method of delivery utilizing one or more stand-by drivers, the administrator computer 12 is configured to receive a business account charge request from either or both of the business 4 and/or the delivery driver 8 (step 236). The business account charge request typically is a request to charge a business account associated with the business 5. In a particular embodiment, the business account charge is first charged to a general administrator merchant account, and later charged to the specific business account associated with the business 5. The business account charge request may be communicated to the administrator computer 12 via the telephone, or alternatively through any suitable electronic communication, such as but not limited to a text message, an email, and/or communication between software applications 28. Once received, the administrator computer may transmit a charge approved notification to the delivery driver 8.

In one or more embodiments of a system or method of delivery utilizing one or more stand-by drivers, the administrator computer 12 is configured to store order information associated with the customer order (step 238). The database may store one or more of the following associated with the customer order: a photo of the customer order as delivered (even if the delivery was left in a particular spot because the customer 4 was not available); a photo of the home of the customer; retailer information; customer information; driver information; time of delivery; type of product; and the like.

In one or more embodiments of a system or method of delivery utilizing one or more stand-by drivers, the administrator computer 12 is configured to transmit a delivery cancellation to the delivery driver 8. The delivery cancellation typically instructions the delivery driver 8 that the customer order has been cancelled by either the business 5 or the customer 4.

FIG. 7 illustrates an exemplary flow chart of a system or method of participating in a pool of stand-by delivery drivers. As the flowchart shown in FIG. 7 is merely one of many embodiments, other embodiments may include additional aspects, exclude certain aspects, or reorder order certain aspects shown in FIG. 7. In one or more embodiments of a system or method of participating in a pool of stand-by delivery drivers, the delivery driver 8 qualifies as a stand-by delivery driver. In particular embodiments, qualifying as a stand-by delivery driver comprises, entering application information (step 302) to a delivery administrator. In some embodiments, the delivery driver enters application information on computers associated with or able to transmit the application information to an administrator computer 12. Qualifying as a stand-by delivery driver further comprises, in one or more embodiments, transmitting documentation (step 304) to the administrator or administrator computer 12, such as but not limited to at least one of an executed contract, tax information, driver's license information, and/or insurance information.

In one or more embodiments of a system or method of participating in a pool of stand-by delivery drivers, the delivery driver 8 logs on as available to deliver customer orders (step 306). The delivery driver may log on to be listed as available on the administrator computer 12 with a text message, email, through a software application 28 on the mobile device of the delivery driver 8, voice activation on the telephone, touch tone, and the like. Once the delivery driver has logged on as available to deliver, the delivery driver is considered part of a stand-by driver pool 70 of potential stand-by drivers as previously described.

In one or more embodiments of a system or method of participating in a pool of stand-by delivery drivers, the delivery driver 8 receives a delivery request (step 308). The delivery driver may receive the delivery request as a phone call, a text message, an email, and/or a push notification on a mobile device and/or computer of the delivery driver 8. The delivery request is typically sent by the administrator computer 12 or administrator associated with the administrator computer. As previously described, the delivery driver may be selected from a pool of stand-by delivery drives, the delivery driver 8 being the highest ranked potential stand-by driver on a ranked list.

In one or more embodiments of a system or method of participating in a pool of stand-by delivery drivers, the delivery driver 8 transmits a delivery response to the administrator and/or the administrator computer 12 (step 310). The delivery response transmitted either accepts, declines, or postpones the delivery request, as previously described. The delivery response may be sent via a software application 28 on a mobile device or computer of the delivery driver, verbal voice recognition, phone calls, touch tone, text message, emails, SMA, and the like.

In one or more embodiments of a system or method of participating in a pool of stand-by delivery drivers, if the delivery response declines the delivery request, then the delivery driver remain in the stand-by driver pool 70; if the delivery response accepts the delivery request, then the delivery driver 8 receives an order authentication (step 312). The order authentication may be as previously described in this application and may be received on any electronic device of the delivery driver.

In one or more embodiments of a system or method of participating in a pool of stand-by delivery drivers, the delivery driver 8 transmits an in-route to business notification (step 314). The in-route to business notification may be sent to at least one of the business 5, the customer 4, and the administrator computer 12 and notes that the delivery driver 8 is in-route to the business 5. The in-route to business notification typically comprises electronic communication sent from the mobile device of the delivery driver, such as but not limited to a text message, email, or data entry on a software application 28.

In one or more embodiments of a system or method of participating in a pool of stand-by delivery drivers, the delivery driver 8 transmits a pick-up notification (step 316). The pick-up notification may be sent to at least one of the customer 4 and the administrator computer 12 and typically notes that the customer order has been picked up from the business 5. The pick-up notification typically comprises electronic communication sent from the mobile device of the delivery driver, such as but not limited to a text message, email, or data entry on a software application 28. In particular embodiments, the delivery driver 8 picks the items from the store, takes them to the checkout, and arranges payment on behalf of the customer 4. In such embodiments, the delivery driver 8 may capture and transmit photographs of the customer order before purchase or checkout to insure that the customer 4 approves of the customer order.

In one or more embodiments of a system or method of participating in a pool of stand-by delivery drivers, the delivery driver 8 transmits an estimated time of arrival notification (step 318). The estimated time of arrival notification may be sent to at least one of the business 5, the customer 4, and the administrator computer 12 and notes an estimated time that the delivery driver 8 will deliver the customer order to the customer 4. The estimated time of arrival notification typically comprises electronic communication sent from the mobile device of the delivery driver, such as but not limited to a text message, email, or data entry on a software application 28.

In one or more embodiments of a system or method of participating in a pool of stand-by delivery drivers, the delivery driver 8 transmits a photograph of the delivery driver to the customer (step 320). The photograph of the delivery driver allows the customer 4 to be familiar or recognize the person delivering the customer order. The photograph typically comprises electronic communication sent from the mobile device of the delivery driver, such as but not limited to a text message, email, or data entry on a software application 28.

In one or more embodiments of a system or method of participating in a pool of stand-by delivery drivers, the delivery driver 8 contacts the customer for additional delivery instructions (step 322). Contacting the customer 4 for additional instructions may be necessary when the driver cannot find the customer's location, does not have access to the customer's location, or if a delay arises (traffic, mechanical problems, etc.). The delivery driver 8 may, in various embodiments, contact the customer 4 via phone communication or electronic communication sent from the mobile device of the delivery driver, such as but not limited to a text message, email, or data entry on a software application 28.

In one or more embodiments of a system or method of participating in a pool of stand-by delivery drivers, the delivery driver 8 charges the customer 4 for the customer order (step 324). Charging the customer order may, in various embodiments, comprise receiving the customer's 4 cash or charging the customer's credit or debit card. In one or more embodiments, if the customer 4 pays with cash, then the delivery driver 8 returns to the business 5 to deliver the cash. In one or more embodiments, if the customer 4 pays with credit or debit cards, then the delivery driver 8 returns to the business 5 to receive cash from the business equal to the tip the custom 4 left on the credit card. Alternatively, in other embodiments, if the customer 4 pays with credit or debit cards, then the delivery drive 8 charges the credit or debit card on the mobile device of the user. Delivery fees and or tips associated with delivery of the customer order may be simultaneously transmitted to an account on the administrator computer 12 associated with the business 5. In still other embodiments, if the customer pays cash, then the delivery driver 8 does not return to the business 5, but instead the administrator and/or administrator computer 12 delivers a period invoice to the business so that the driver is not required to return to the business 12. In further embodiments, the customer 4 pays for the customer order prior to delivery of the customer order by the delivery driver 8. In such embodiments, the driver may collect the cash tip from the customer 4 without returning to the business 5, or, alternatively, the business 5 may settle accounts with the administrator when the customer 4 prepays the delivery driver tip.

In one or more embodiments of a system or method of participating in a pool of stand-by delivery drivers, the delivery driver 8 transmits a customer signature to at least one of the administrator computer 12 and the business 5 (step 326). The customer signature typically presents a verification by the customer 4 that the customer 4 has accepted the customer order and/or that the customer's 4 credit or debit card may be charged. The customer signature is typically transmitted via electronic communication sent from the mobile device of the delivery driver, such as but not limited to a text message, email, or data entry on a software application 28. In alternative embodiments, the customer's 4 signature is obtained on a paper copy that is later physically delivered to the business 4 or transmitted as an electronic copy to the business 4.

In one or more embodiments of a system or method of participating in a pool of stand-by delivery drivers, the delivery driver 8 transmits delivery notification (step 328). The estimated delivery notification may be sent to at least one of the business 5, the customer 4, and the administrator computer 12 and notes that the delivery driver 8 has delivered the customer order to either the customer 4 or the left the customer order on the premises of the customer 4. The delivery notification typically comprises electronic communication sent from the mobile device of the delivery driver 8, such as but not limited to a text message, email, or data entry on a software application 28.

In one or more embodiments of a system or method of participating in a pool of stand-by delivery drivers, the delivery driver 8 transmits an available notification (step 318). The available notification may be sent to the administrator computer 12 and notes that the delivery driver 8 is available for a new delivery request. As such, the available notification places the delivery driver 8 in the stand-by driver pool 70, and the process may be repeated. The available notification typically comprises electronic communication sent from the mobile device of the delivery driver, such as but not limited to a text message, email, or data entry on a software application 28. At any point while the delivery driver is in the stand-by driver pool 70, the delivery driver 8 may log off to remove him/herself from the stand-by driver pool 70.

In one or more embodiments, the delivery driver 8 contacts the business to determine the appropriate action when the customer 4 refuses the customer order. In still other embodiments, the delivery captures a photograph of the customer order as delivered and transmits the photograph to the administrator computer 12. The photograph may then be stored in an administrator database as proof of delivery.

In one or more embodiments of a system or method of participating in a pool of stand-by delivery drivers, the delivery driver 8 transmits a delivery cancellation at any point during the method or system. The delivery cancellation may be due to customer refusal, mechanical problems, dangerous situation, the customer 4 cannot pay, the customer order is wrong, and the like. The delivery cancellation may be sent to at least one of the administrator computer 12, the business 5, and/or the customer 4, and typically comprises either phone communication or electronic communication sent from the mobile device of the delivery driver, such as but not limited to a text message, email, or data entry on a software application 28.

One of more embodiments disclosed herein comprise a software application 28 configured to carry out one or more of the steps or system aspects previously described in this document. For example, one or more embodiments of a software application 28 is configured to be downloadable on a mobile device or personal computer of a stand-by delivery driver. Once on the mobile device or computer of the stand-by deliver driver, the software application may be configured to perform one or more of the following: transmit documentation, log the stand-by delivery driver into the stand-by driver pool 70, receive a deliver request, transmit a delivery response, receive an order authentication, transmit an in-route to business notification, transmit a pick-up notification, transmit an estimated time of arrival, transmit a photograph of the delivery driver, contact the customer 4 for delivery instructions, charge the customer 4 for the customer order, transmit the customer signature, transmit a delivery notification, and the like.

The software application 28 is, in some embodiments, configured for application to the administrator computer 12. Thus, in one or more embodiments, the software application 28 is configured to perform one or more of the following on an administrator computer 12: receive a deliver request, determine a ranked list of potential drivers, select a potential stand-by driver, transmit a delivery request to the potential stand-by driver, receive a delivery response from the potential stand-by driver, assign the potential stand-by driver as a deliver driver, transmit an order authentication to the delivery driver, transmit an estimated business arrival time notification, receive a pick-up notification, transmit a driver-in-route notification, transmit an estimated customer arrival time notification, provide real-time global positioning of the delivery driver, receive a delivery notification, and receive business account charge requests.

The software application 28 is, in some embodiments, configured for application to a computer or other electronic device of the business 5. Thus, in one or more embodiments, the software application 28 is configured to perform one or more of the following on a computer or other electronic device of a business 5: transmit a delivery request, receive an order authentication, receive an estimated business arrival time notification, transmit a pick-up notification, transmit a driver-in route notification, transmit an estimated customer arrival time notification, monitor the real-time global positioning of the delivery driver, receive a delivery notification, and receive charge associated with the customer order.

The software application 28 is, in some embodiments, configured for application to a computer or other electronic device of the customer 4. Thus, in one or more embodiments, the software application 28 is configured to perform one or more of the following on a computer or other electronic device of a customer 4: transmit a delivery request, receive an estimated business arrival time notification, receive a driver-in-route notification, receive an estimated customer arrival time notification, monitor real-time global positioning of the delivery driver, receive a delivery notification, and receive a receipt associated with the delivery of the order.

Where the examples, embodiments and implementations provided herein reference mobile devices, cellular phones, cellular phone networks and other cellular phone examples, it should be understood by those of ordinary skill in the art that other phone types, networks, any other telephony devices and examples could be intermixed or substituted with those provided. Routing of communication connections between various communications devices may be done similar to the examples provided above relating to a phone service network. Accordingly, the disclosed subject matter is intended to embrace all such alterations, modifications and variations that fall within the spirit and scope of the appended claims. Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

It will be understood that implementations are not limited to the specific components disclosed herein, as virtually any components consistent with the intended operation of a method and/or system implementation for stand-by delivery drivers may be utilized. Accordingly, for example, although particular mobile devices and computers may be disclosed, such components may comprise any shape, size, style, type, model, version, class, grade, measurement, concentration, material, weight, quantity, and/or the like consistent with the intended operation of a method and/or system implementation for a stand-by delivery driver system and method may be used.

In places where the description above refers to particular implementations of stand-by delivery driver systems and methods, it should be readily apparent that a number of modifications may be made without departing from the spirit thereof and that these implementations may be applied to other delivery systems and methods. The accompanying claims are intended to cover such modifications as would fall within the true spirit and scope of the disclosure set forth in this document. The presently disclosed implementations are, therefore, to be considered in all respects as illustrative and not restrictive, the scope of the disclosure being indicated by the appended claims rather than the foregoing description. All changes that come within the meaning of and range of equivalency of the claims are intended to be embraced therein.

1. A computer-implemented method of delivery, comprising:
receiving a delivery request for a customer order, the customer order associated with a business;
selecting, by a computer, a first potential stand-by driver to deliver the customer order, the first potential driver selected from a pool of a plurality of potential stand-by delivery drivers, each of the plurality of potential stand-by drivers being independent of the business and permitted to accept or decline a delivery request;
transmitting, by the computer, the delivery request to the first potential stand-by driver;
receiving, by the computer, a first delivery response from the first potential stand-by driver, the delivery response accepting or declining the delivery request;
assigning, by the computer, the first potential stand-by driver as a delivery driver if the first potential driver accepts a delivery request of the customer order;
transmitting, by the computer, an order authentication to the delivery driver;
receiving, by the computer, a pick-up notification when the delivery driver picks up the customer order from the business; and
receiving, by the computer, a delivery notification when the delivery driver delivers the customer order to the customer.

2. The computer-implemented method of claim 1, further comprising receiving, by the computer, a logon request from each of the plurality of potential stand-by drivers in the pool, each of the plurality of potential stand-by drivers

3. The computer-implemented method of claim 2, further comprising:
selecting, by the computer, a second potential stand-by driver to deliver the customer order when the first potential stand-by driver declines the delivery request in the first delivery response, the second potential stand-by driver selected from the pool of potential stand-by delivery drivers;
transmitting, by the computer, the delivery request to the second potential driver;
receiving, by the computer, a second delivery response from the second potential stand-by driver, the second delivery response accepting or declining the delivery request; and
assigning, by the computer, the second potential stand-by driver as a delivery driver if the second potential stand-by driver accepts a delivery request of the customer order.

4. The computer-implemented method of claim 3, wherein receiving the delivery request for the customer order comprises receiving, by the computer, the delivery request for the customer order from the customer.

5. The computer-implemented method of claim 3, wherein receiving the delivery request for the customer order comprises receiving, by the computer, the delivery request for the customer order from the business.

6. The computer-implemented method of claim 5, further comprising determining, by the computer, a ranked list of potential stand-by drivers from the pool of drivers, the ranked list based one or more driver criteria, wherein the first potential stand-by driver is ranked first on the ranked list and the second potential stand-by driver is ranked second on the ranked list.

7. The computer-implement method of claim 6, wherein:
transmitting the delivery request to the first potential stand-by driver comprises transmitting the delivery request to a mobile device of the first potential stand-by driver with at least one of a text message, an email, or a push notification associated with an application on the mobile device;
receiving the first delivery response from the first potential stand-by driver comprises receiving the first delivery response sent from the mobile device of the first potential stand-by driver, the first delivery response comprising at least one of a text message, an email, or a push notification that accepts or declines the delivery request;
transmitting the delivery request to the second potential stand-by driver comprises transmitting the delivery request to a mobile device of the second potential stand-by driver with at least one of a text message, an email, or a push notification associated with the application on the mobile device of the second potential stand-by driver;
receiving the second delivery response from the second potential stand-by driver comprises receiving the second delivery response sent from the mobile device of the second potential stand-by driver, the second delivery response comprising at least one of a text message, an email, or a push notification associated that accepts or declines the delivery request;
transmitting the order authentication to the delivery driver comprises transmitting the order authentication to the mobile device of the delivery driver with at least one of a text message, email, or a push notification associated with the application on the mobile device of the delivery driver, the order authentication comprising at least one of a receipt, a code, a bar code configured to display on a mobile device of the delivery driver.

8. The computer-implemented method of claim 7, further comprising:
transmitting, by the computer, an estimated arrival time notification to at least one of the customer and the business;
transmitting, by the computer, an driver-in-route notification to at least one of the customer and the business; and
providing, by the computer, real-time global positioning of the delivery driver.

9. The computer-implemented method of claim 8, further comprising:
receiving, by the computer, a business account charge request from the mobile device of the delivery driver;
charging, by the computer, a business account associated with the business a charge associated with delivery of the customer order; and
storing, on an administrator database in communication with the computer, customer order information.

10. A method of participating in a pool of stand-by delivery drivers, comprising:
qualifying as a stand-by delivery driver;
receiving, on a mobile device associated with the stand-by delivery driver, a delivery request from an administrator computer, the stand-by delivery driver selected by the administrator computer based on one or more driver criteria and the delivery request requesting delivery of a customer order associated with a business;
transmitting, by the mobile device, a delivery response to the administrator computer, the delivery response accepting or declining the delivery request;
receiving, on the mobile device, an order authentication when the delivery response is accepted;
transmitting, by the mobile device, a pick-up notification to the administrator computer when the customer order has been picked up from the business; and
transmitting, by the mobile device, a delivery notification to the administrator computer when the customer order is delivered to a customer.

11. The method of claim 10, further comprising installing application software on the mobile device.

12. The method of claim 11, further comprising logging on, with the mobile device, as available to deliver on the administrator computer.

13. The method of claim 12, further comprising one or more of the following:
cancelling, with the mobile device, delivery request;
transmitting, by the mobile device, an estimated time of arrival to at least one of the business, the customer, and the administrator computer;
transmitting, by the mobile device, a photograph of the delivery driver to at least one of the business and the customer;
transmitting, by the mobile device, a signature of the customer to the administrator computer;
charging, on the mobile device, the customer for the customer order;
capturing, with the mobile device, a photograph of the customer order when the customer order is delivered; and
contacting, with the mobile device, the customer to receive one or more additional delivery instructions.

14. The method of claim 12, wherein receiving on the mobile device comprises receiving at least one of a text message, an email, or a push notification associated with an application on the mobile device, and transmitting by the mobile device comprises transmitting at least one of a text message, an email, or a push notification associated with the application from the mobile device.

15. The method of claim 12, wherein qualifying as a stand-by delivery driver comprises:
entering, on a computer, application information, the application information comprising at least one of personal information of the stand-by delivery driver, education, work experience, references, certification, vehicle information, and availability; and
transmitting at least one of an executed contract, tax information, driver's license information, and insurance information to the administrator computer when the application information is approved.

16. A computer-implemented delivery system, comprising:
one or more computers associated with a central processor, the one or more computers configured to:
receive, from either a restaurant or a customer, a delivery request for a customer order;
determine a ranked list of potential drivers from a pool of a plurality of stand-by drivers, the ranked list based one or more driver criteria and each of the plurality of stand-by drivers being independent of the business and permitted to accept or decline a delivery request;
transmit to a first potential driver the delivery request to deliver the customer order, the first potential driver ranked first on the ranked list of potential drivers;
receive a first delivery response from the first potential driver, the first delivery response accepting or declining the delivery request;
assign the first potential driver as a delivery driver if the first potential driver accepts the delivery request;
transmit to a second potential driver the delivery request to deliver the customer order when the first potential driver declines the delivery request, the second potential driver ranked below the first potential driver on the ranked list of potential drivers;
receive a second delivery response from the second potential driver, the second delivery response accepting or declining the delivery request;
assign the first potential driver as a delivery driver when the first potential driver accepts the delivery request;
assign the second potential driver as the delivery driver when the second potential driver accepts the delivery request;
transmit an order authentication to the delivery driver;
receive a pick-up notification when the delivery driver picks up the customer order from the restaurant; and
receive a delivery notification when the delivery driver delivers the customer order to a customer.

17. The computer-implemented system of claim 16, wherein the computer is configured to transmit the delivery request and the order authentication to the first potential driver and the second potential driver as at least one of a text message, an email, or a push notification associated with an application on a mobile device of the first potential driver or the second potential driver, and wherein the computer is configured to receive the first delivery response from the first potential driver sent from the mobile device of the first potential driver, the second deliver response sent from the mobile device of the second potential driver, and the pick-up notification and the delivery notification sent from the mobile device of the delivery driver as a text message, an email, or information entered into the API on the mobile device.

18. The computer-implemented delivery system of claim 17, wherein the computer is further configured to:
transmit an estimated arrival time notification to at least one of the customer and the restaurant;
transmit a driver-in-route notification to at least one of the customer and the restaurant; and
transmit real-time global positioning of the delivery driver.

19. The computer-implemented delivery system of claim 18, wherein the computer is further configured to:
receive a restaurant account charge request from the mobile device of the delivery driver; and
charge a restaurant account associated with the restaurant a charge associated with delivery of the customer order.

20. The computer-implemented delivery system of claim 19, further comprising a database in communication with the computer, the database configured to receive and store delivery information.
